(19) United States
(12) Patent Application Publication
(10) Pub. No.: US 2003/0154639 A1
(43) Pub. Date: Aug. 21, 2003

(54) Apparatus, system and method for displaying and providing customizable and changeable signs

(76) Inventors: Scott D. Bowers, Lebanon, OH (US); Ronald L. Fogle, Springboro, OH (US)

Correspondence Address: GRAYDON HEAD AND RITCHEY LLP, 1900 FIFTH THIRD CENTER, 511 WALNUT STREET, CINCINNATI, OH, 45202, US

(21) Appl. No.: 10/365,088

(22) Filed: Feb. 12, 2003

Related U.S. Application Data
(60) Provisional application No. 60/356,265, filed on Feb. 12, 2002.

(51) Int. Cl. G09F 3/18

(52) U.S. Cl. 40/611.1; 40/642.02

(57) ABSTRACT

A display frame apparatus for displaying a custom sign insert. The display frame apparatus comprises a sign body, a transparent front cover lens and at least one frame element. The sign body includes front and back faces; upper, lower and opposite side edges; and at least two connector receiving members located adjacent to and at spaced locations along a single side edge. The transparent front cover lens is releasably attached to the front face of the sign body. The frame element includes at least two connector members adapted to mate with the connector receiving members for releasably attaching the frame element to the sign body.

### CROSS REFERENCE TO RELATED APPLICATIONS

The present application claims the benefit of U.S. Provisional Patent Application No. 60/356,265, filed Feb. 12, 2002.

### FIELD OF THE INVENTION

The present invention relates, in general, to multi-purpose signage and display systems. More particularly, the present invention relates to a multi-purpose display frame apparatus, a custom display system and methods for displaying computer generated customizable and changeable signs.

### BACKGROUND

We have all seen traditional message boards for so many years, in so many different locations, for example, on the school wall, in the doctor's waiting room and on a stand outside a parking garage. In a general sense, such known applications very ably provide for the display of information. However, such known applications have been homogenized into an icon—black, poster-sized framed rectangles, horizontally grooved, with white, old-fashioned fonts; the individual letters slightly askew, unevenly spaced, with at least one odd substitute letter or number (the wrong case, point-size, or up-side down) often behind glass (clean on the outside with a poorly housekept interior).

Message boards are intended to be individualized (to reflect the organization for whom they “speak”) and regularly revised (to reflect current information)—but like track lighting, message boards are rarely properly updated after initial setup (often a handwritten, taped-in place note substitutes for the contents of the misplaced font storage box, to revise the message).

But our world and its “messaging” has radically evolved toward professional presentation—and graphics now constantly compete for our visual attention. The prior art message board's associated visuals (layout, color, fonts, frame style and materials) have become outdated—while organizations and individuals expect to be “spoke for and to” in a manner that accurately reflects the intended image of both the “speaker” and the message's audience. “One-size” no longer fits all—the “speaker” may be as diverse as a SoHo entrepreneur, an internet start-up's warehouse office, an environmental-interest club, a social/religious group, an “old-economy” global industrial conglomerate, or civic/governmental organizations seeking “relevance”. Additionally, the prior art message boards no longer reflect the “speaker” and are no longer compatible with common communications procedures (word processing) or equipment (computers/printers/papers) used by most message board target-market categories. Especially for commercial purposes, it is often necessary to quickly change the sign or display, and while the aforementioned letter boards can be changed or updated, it would be advantageous for a display system to have a display frame by which an individual can easily exchange computer generated display material to allow for easy updating or changing of the displayed material.

Many prior art display systems suffer from the disadvantages of being expensive and inflexible. Most efforts to upgrade, modernize and style products of the prior art message boards involve the shape and materials of the frame and its stands and mounting. Little or no effort has been made to assist the user to efficiently create personalized, impactful, effective and memorable messages. There is a need for a low-cost system for creating custom displays without special training, tools or equipment. Such a system should provide a wide range of choices in font styles and scales, background and type colors, frames, mat options and combinations of icons, logos, photos and art.

The present invention addresses some of these short comings of the prior art. Heretofore there has not been available a signage and display system with the advantages and features of the present invention.

### SUMMARY

In accordance with one embodiment of the present invention there is provided a display frame apparatus for displaying a custom sign insert. The display frame apparatus includes a sign body, a transparent front cover lens and at least one frame element. The sign body includes front and back faces; upper, lower and opposite side edges; and at least two connector receiving members located adjacent to and at spaced locations along a single side edge. The transparent front cover lens is releasably attached to the front face of the sign body so as to define therebetween a space for receiving and displaying the custom sign insert and when the custom sign insert is inserted between the sign body and front cover lens the custom sign insert is held neatly in place within the display frame apparatus. The at least one frame element includes at least two connector members adapted to mate with the connector receiving members for releasably attaching the frame element to the sign body.

In accordance with another embodiment of the present invention, a custom display system for providing customizable and changeable signs is provided. The custom display system includes a display frame apparatus for displaying a custom sign insert, a computer for creating customizable indicia conveyed by the custom sign insert and a printer. The display frame apparatus includes a sign body having front and back faces and a transparent front cover lens releasably attached to the front face of the sign body so as to define therebetween a space for receiving and displaying the custom sign insert and when the custom sign insert is inserted between the sign body and front cover lens the custom sign insert is held neatly in place within the display frame apparatus. The printer is in communication with the computer for printing the customizable indicia on the custom sign insert.

Also provided is a method of providing customizable and changeable signs. The method includes the steps of providing a computer, a printer and a display frame apparatus having a sign body including front and back faces and a transparent front cover lens releasably attached to the front face of the sign body, creating customizable indicia using the computer, connecting the printer to the computer and downloading print files containing customizable indicia from the computer to initiate printing of the customizable indicia by the printer onto the custom sign insert and inserting the custom sign insert between the sign body and the front cover lens for display.

Still other embodiments, examples, features, aspects, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description taken in conjunction with the accompanying drawings, in which like reference numerals identify the same elements and in which:

FIG. 1 illustrates an example of a display frame apparatus in accordance with the present invention.

FIG. 2 illustrates an example of a layer of elements located between a sign body and a front cover lens in accordance with the present invention.

FIG. 3 illustrates an example of a mounting plate and a sign body in accordance with the present invention.

FIG. 4 illustrates an example of a mounting plate connected to the back face of a sign body in accordance with the present invention.

FIG. 5 illustrates an example of a close-up perspective view of a frame element and sign body in accordance with the present invention.

FIG. 6 illustrates an example of a frame element insert in accordance with the present invention.

FIG. 7 illustrates an example of a close-up perspective view of two sign bodies being connected in accordance with the present invention.

FIG. 8 illustrates an example of a custom display system in accordance with the present invention.

### DETAILED DESCRIPTION

Reference will now be made in detail to various embodiments of the present invention, examples of which are illustrated in the accompanying drawings wherein like numerals indicate the corresponding structure throughout the views. As will be understood hereafter, the disclosed embodiments are merely exemplary of the invention, which may be embodied in various forms. Therefore, specific structural and functional details disclosed herein are not to be interpreted as limiting, but merely a basis for the claims and as a representative basis for teaching one skilled in the art to variously employ the present invention in virtually any appropriately detailed structure.

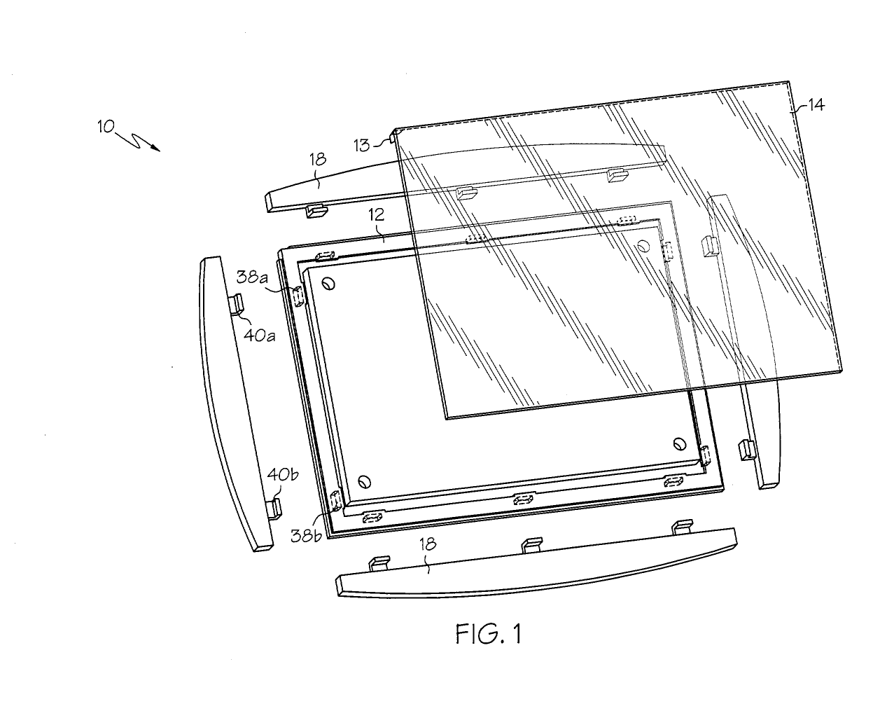

Referring now to the drawings in more detail and initially to FIG. 1, there is shown an example of a display frame apparatus 10 for displaying a custom sign insert. In the present example, the display frame apparatus 10 includes a sign body 12, a front cover lens 14 and frame element 18. In one example, sign body 12, mounting plate 16 and frame element 18 are formed of plastic. Examples of other suitable materials include, but are not limited to wood, metal or ceramic. Display frame apparatus 10 of the present invention is applicable for use in a variety of settings where it is desirable to convey information to people in an efficient and organized manner, for example, public environments, architectural environments, restaurant environments, institutional environments and the like.

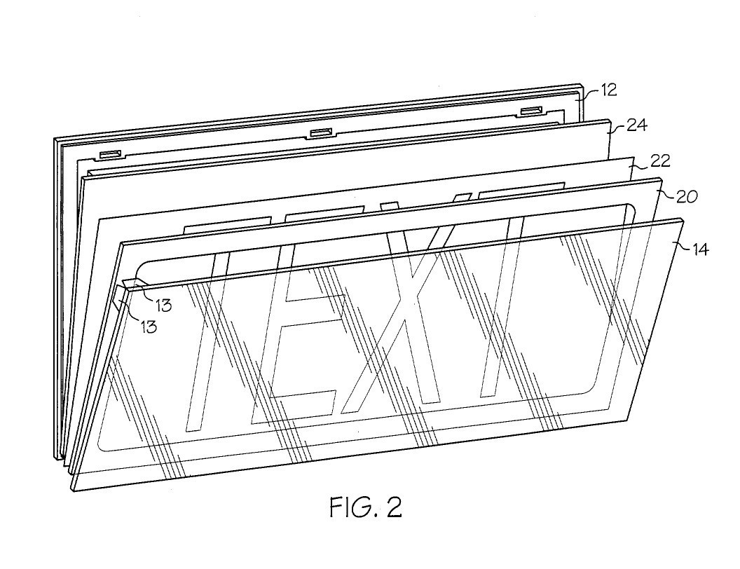

As best seen in FIG. 2, there is shown a compressible sandwich of elements or layers between sign body 12 and front cover lens 14. Beginning with the layer closest to the customer when display frame apparatus 10 is in use, the layers are transparent front cover lens 14, accessory mat 20, custom sign insert 22 and suspension layer 24. Preferably, transparent front cover lens 14 is formed of plastic, such as LEXAN, available from General Electric. Front cover lens 14 is provided to protect the layers located behind it, while still allowing visibility of such other layers.

Located immediately behind front cover lens 14 is an optional accessory mat 20. Accessory mat 20 comprises a window formed therein to allow viewing of the custom sign insert layer. Accessory mat 20 may take many sizes and forms and may consist of a wide variety of colors and designs, for example, it may consist of a holiday design. In one example, accessory mat 20 is formed of cardstock. Examples of other suitable materials include, but are not limited to, film, plastic or paper.

Located immediately behind accessory mat layer 20 is a custom sign insert layer 22. There is a wide flexibility of the material which may be used for custom sign insert layer 22. In one example, custom sign insert layer 22 is formed of standard office-sized paper, for example, letter size, A4 size, legal size and tabloid/ledger size. Examples of other suitable materials include, but are not limited to, labels, film, foil or clear transparencies. The side of custom sign insert 22 carrying information to be conveyed is visible through front cover lens 14. For added versatility, the information to be conveyed may take many forms, for example it may consist of letters, numbers, icons, logos, photos, artwork, graphics or other pictorial material or any combination of these, collectively known as customizable indicia. In the example shown in FIG. 2, the customizable indicia is represented by the word “GHENT”. The customizable indicia is created using information stored on any computer readable medium and printing the customizable indicia on custom sign insert 22 using any standard laser or ink jet printer in communication with a computer. It is expected that customizable indicia may continue to be generated and custom sign insert 22 replaced as display frame 10 is in use to meet the needs of particular users.

Accordingly, as shown in FIG. 1, front cover lens 14 is attached to sign body 12 by inserting release tab 13 into similarly shaped depressions on sign body 12 so that custom sign insert 22 may be removed from display frame apparatus 10 and replaced by another custom sign insert as desired by pressing release tab 13 to separate front cover lens 14 from sign body 12. Custom sign insert 22 is replaced by sliding one custom sign insert 22 out and another custom sign insert in. While a release tab is preferred to connect front cover lens 14 to sign body 12, one skilled in the art would recognize that additional connector means could also be used with equal facility, such as a latch, retaining clip or other such connection mechanisms. Preferably, release tab 13 is located at each corner of front cover lens 14 and protrudes to allow for finger location.

Located immediately behind custom sign insert 22 is suspension layer 24. Suspension layer 24 helps maintain the stability of custom sign insert 22. In one example, suspension layer 24 is formed of foam, such as polyurethane or other compressible material.

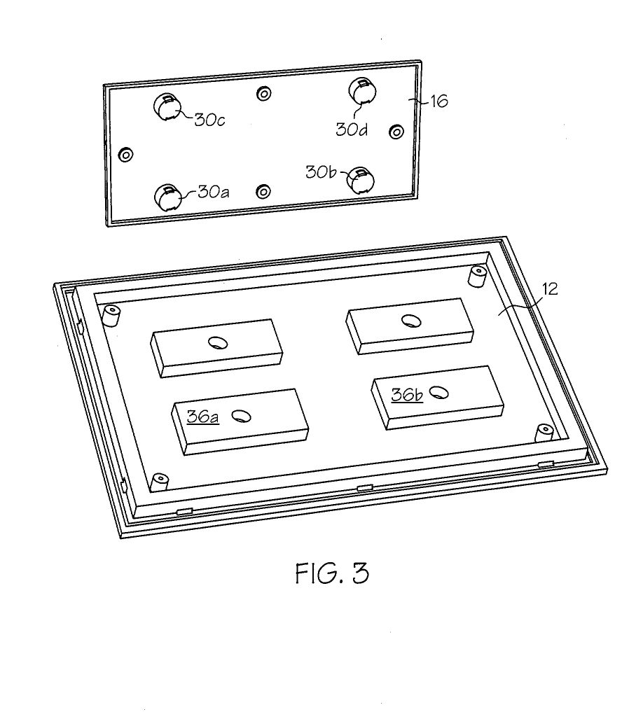

As shown in FIG. 3, the present invention may also include an optional mounting plate 16 to prevent tampering or theft of custom sign insert 22. In the example shown in FIG. 3, mounting plate 16 comprises at least two support post members 30a and 30b. Support post members 30a and 30b are cylindrical in shape and include connector elements to interconnect mounting plate 16 to the back face of sign body 12. Support post members 30a and 30b extend outwardly relative to the front face of mounting plate 16 and have uniform height. In a preferred embodiment, four support post members, 30a, 30b, 30c and 30d are located on the front face of mounting plate 16 and are uniformly spaced to define a rectangle. Mounting plate 16 also includes a wall 32 outstanding from the front face and bounding the perimeter of the front face. In a preferred embodiment, support post members 30a, 30b, 30c and 30d have greater height than the wall. It should be noted that while the preferred shape, configuration and number of support post members have been described above, these arrangements may be varied depending on the desired application.

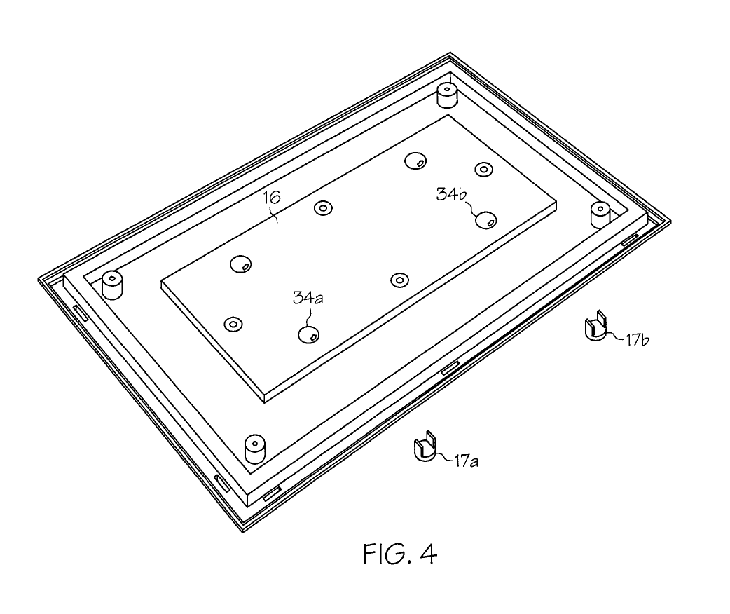

In the example shown in FIG. 4, mounting plate 16 also comprises at least two mounting snap receiving members 34a and 34b. Mounting snap receiving members 34a and 34b are located on the back face of mounting plate 16 and are hollow, cylindrical in shape and are adapted to receive mounting snap members 17a and 17b. Once mounting snap members 17a and 17b are received into mounting snap receiving members 34a and 34b, mounting plate 16 is securely locked to sign body 12 to prevent tampering with custom sign insert 22 contained within display frame apparatus 10.

In the example shown in FIG. 3, the back face of sign body 12 comprises at least two support post receiving members 36a and 36b. In the example shown in FIG. 3, support post receiving members 36a and 36b are hollow, cylindrical in shape and are adapted to receive support post members 30a and 30b. The connector elements located on support post members 30a and 30b are received into support post receiving members 36a and 36b to interconnect mounting plate 16 to the back face of sign body 12. Preferably, the shape, size, number and arrangement of the support post receiving members correspond with the shape, size, number and arrangement of the support post members to allow the support post members to mate with the support post receiving members.

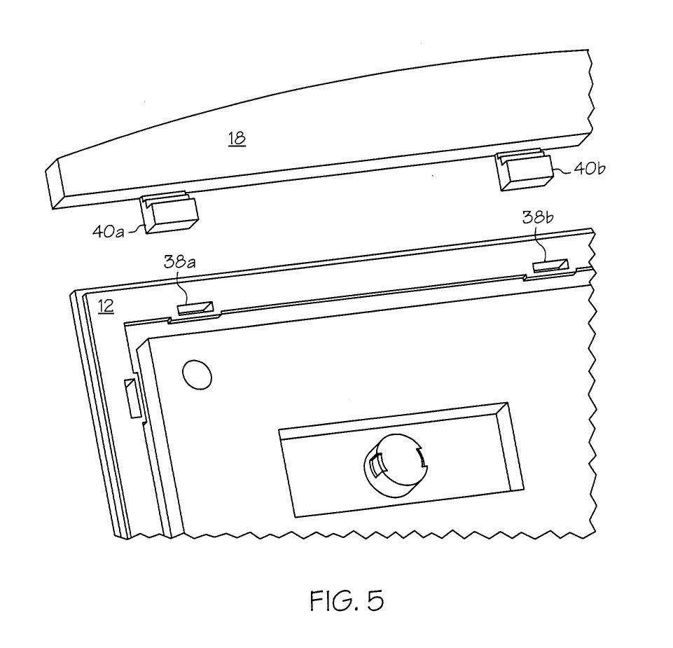

Referring now to FIG. 5, connector receiving members 38a and 38b (shown in phantom in FIG. 1) are formed in a side edge of the back face of sign body 12 and are located in a uniform spaced location along that edge. In one example, upper and lower side edges of sign body 12 include at least three connector receiving members, while opposite side edges of sign body 12 include at least two connector receiving members. In FIG. 5 there is also shown frame element 18. Frame element 18 comprises at least two connector members 40a and 40b adapted to mate with connector receiving members 38a and 38b. Connector members 40a and 40b are received into connector receiving members 38a and 38b to interconnect frame element 18 to the back face of sign body 12. In one example, connector members 40a and 40b comprise cleat-shaped connectors. In the example shown in FIG. 5, frame element 18 is formed of a clear material, such as plastic. Examples of other suitable materials include, but are not limited to, metal, wood or ceramic. In one example, frame element 18 comprises a generally elliptical shape. While elliptical shaped frame elements are shown in FIG. 5, frame elements of other shapes, such as oval, triangular, square, rectangular and pentagonal, may be used, if desired.

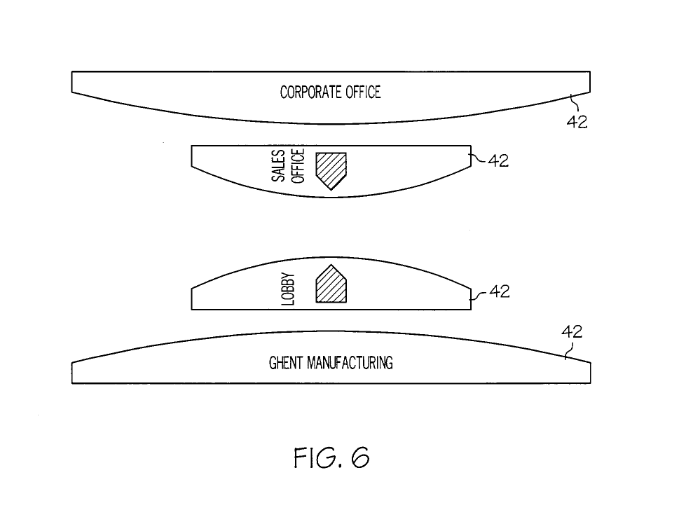

Referring now to FIG. 6, frame element 18 may be adapted to carry frame element insert 42 containing customizable indicia similar to custom sign insert 22. In the example shown in FIG. 6, frame element insert 42 is formed of micro perforated paper or labels sized to fit within frame element 18 and compatible for use with a printer. The side of frame element insert 42 carrying information to be conveyed is visible through frame element 18. While elliptical shaped frame element inserts are shown in FIG. 6, frame element inserts of other shapes, corresponding to the shape of the frame element, such as oval, triangular, square and pentagonal, may be used, if desired.

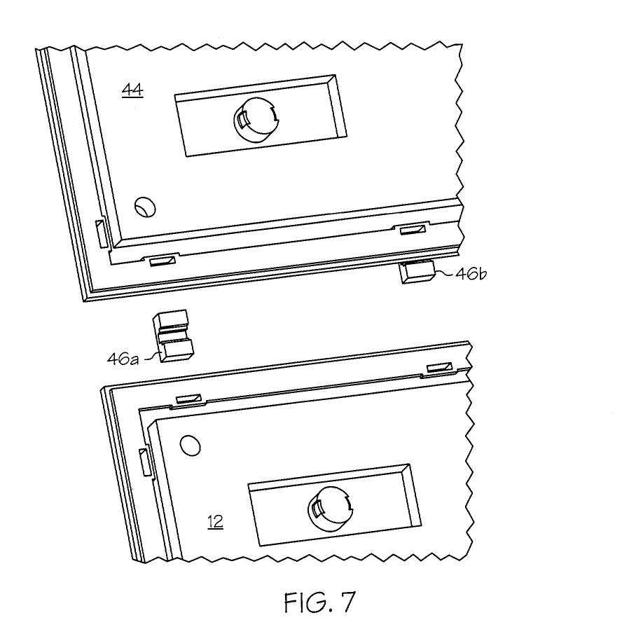

Referring now to FIG. 7, frame element 18 may comprise a second sign body 44. Use of second sign body 44 as a frame element allows two or more display frames to be connected in a side-by-side relation and mounted on a support surface. In the example shown in FIG. 7, second sign body 44 is connected to sign body 12 with cleat-shaped connector members 46a and 46b in the same fashion as described above with respect to connector members 40a and 40b in FIG. 5.

In operation, display frame apparatus 10 provides tremendous flexibility. Accordingly, display frame apparatus 10 can be used in a variety of different ways for displaying information, including, but not limited to, wall mounting, door mounting, column mounting, pedestal mounting and hanging installations.

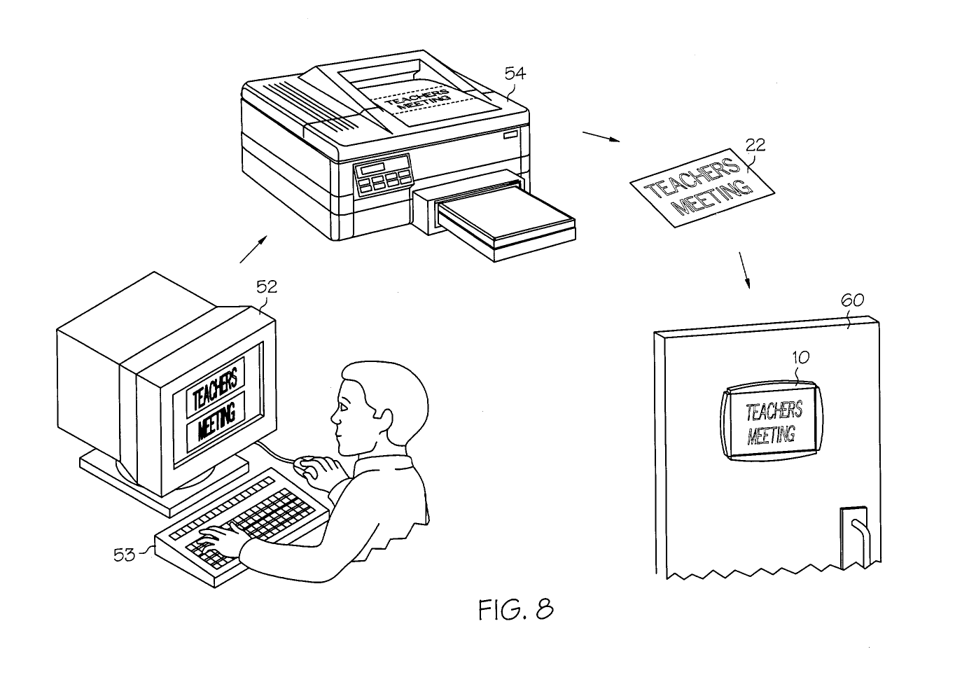

FIG. 8 illustrates a custom display system 50 according to the present invention for providing customizable and changeable signs. Custom display system 50 comprises standard computer 52, printer 54, and display frame apparatus 10 mounted on support surface 60. Standard computer 52 may be a personal computer, workstation, laptop or other computer platform now or later developed. Standard computer 52 includes known components including a processor, an operating system, memory and input device 53. It will be understood by those skilled in the relevant art that there are many possible configurations of the components of computer 52 and that some components that may typically be included in computer 52 are not shown, such as a video card, data backup unit and many other devices.

Input device 53 could include any of a variety of known devices for accepting information from a user. Such devices include, for example, a keyboard, mouse, touch-screen display or touch pad. Printer 54 could include any of a variety of known output devices for presenting information to a user. Such devices include, for example, ink jet printers, laser printers, banner printers and copiers.

Display frame apparatus 10 includes sign body 12, custom sign insert 22 and transparent front cover lens 14. These components are shown in detail in FIG. 1.

With reference to FIGS. 1-8, a method according to the present invention is directed to providing customizable and changeable signs. Computer 52, printer 54 and display frame apparatus 10 are provided. Computer software programs typically are stored in the memory of computer 52 or on a computer readable medium. Such computer software programs when executed by a processor, enable computer 52 to perform the functions of the present invention as described herein. In one example, computer software programs are stored on a computer readable medium which when executed by computer 52 allow a user to create a custom sign insert using input device 53 and printer 54.

One with ordinary skill in the art will readily appreciate that the computer software programs used for creating customizable and changeable signs can be stored on any computer readable medium. Computer readable medium can take a variety of forms including magnetic storage (such as hard disk drives, floppy diskettes, tapes, etc.), optical storage (such as laser disks, compact disks, etc.), electronic storage (such as random access memory “RAM,” read-only memory “ROM,” programmable read-only memory “PROM,” etc.), and the like. Preferably, the computer readable medium will be in the form of compact disks.

Finally, computer 52 is connected to printer 54 and print files containing customizable indicia are downloaded from computer 52 to printer 54 and printed onto custom sign insert 22 for display in display frame apparatus 10.

Having shown and described various embodiments of the present invention, further adaptations of the display frame apparatus and custom display system described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

What is claimed is:

1. A display frame apparatus for displaying a custom sign insert comprising:
(a) a sign body having front and back faces; upper, lower and opposite side edges; and at least two connector receiving members located adjacent to and at spaced locations along a single side edge.
(b) a transparent front cover lens releasably attached to the front face of the sign body so as to define therebetween a space for receiving and displaying the custom sign insert and when the custom sign insert is inserted between the sign body and front cover lens the custom sign insert is held neatly in place within the display frame apparatus; and
(c) at least one frame element having at least two connector members adapted to mate with the connector receiving members for releasably attaching the frame element to the sign body.

2. The display frame apparatus according to claim 1, wherein the sign body comprises at least two support post receiving members in the back face at spaced locations, the support post receiving members defining hollows in the back face of the sign body.

3. The display frame apparatus according to claim 1, further comprising a suspension layer located between the sign body and the custom sign insert for maintaining the stability of the custom sign insert.

4. The display frame apparatus according to claim 3, wherein the suspension layer is foam.

5. The display frame apparatus according to claim 1, further comprising a mat layer located between the front cover lens and the custom sign insert, the mat layer having a window formed therein to permit viewing of the custom sign insert.

6. The display frame apparatus according to claim 2, further comprising a mounting plate having front and back faces; upper, lower and opposite side edges; and at least two support post members outstanding relative to the front face at spaced locations, the support post members adapted to mate with the support post receiving members for releasably attaching the mounting plate to the sign body.

7. The display frame apparatus according to claim 1, wherein the custom sign insert includes information consisting of customizable indicia.

8. The display frame apparatus according to claim 6, wherein the support post members have greater height than the wall.

9. The display frame apparatus according to claim 6, wherein the mounting plate comprises a wall outstanding from the front face and bounding the perimeter of the front face; and at least two mounting snap receiving members in the back face at spaced locations, the mounting snap receiving members defining hollows in the back face of the mounting plate and adapted to mate with mounting snap members for securing the display frame apparatus to a support surface.

10. The display frame apparatus according to claim 1, wherein the frame element is transparent.

11. The display frame apparatus according to claim 10, wherein the frame element is adapted to carry a frame element insert containing information consisting of customizable indicia.

12. The display frame apparatus according to claim 1, wherein the frame element comprises a generally elliptical shape.

13. The display frame apparatus according to claim 1, wherein the connector member comprises a cleat connector.

14. The display frame apparatus according to claim 1, wherein the frame element is a second sign body.

15. A custom display system for providing customizable and changeable signs, the system comprising:
(a) a display frame apparatus for displaying a custom sign insert comprising
(i) a sign body having front and back faces;
(ii) a transparent front cover lens releasably attached to the front face of the sign body so as to define therebetween a space for receiving and displaying the custom sign insert and when the custom sign insert is inserted between the sign body and front cover lens the custom sign insert is held neatly in place within the display frame apparatus; and
(b) a computer for creating customizable indicia conveyed by the custom sign insert; and
(c) a printer in communication with the computer for printing the customizable indicia on the custom sign insert.

16. The system according to claim 15, wherein the sign body comprises upper, lower and opposite side edges.

17. The system according to claim 16, further comprising at least one frame element releasably attached to one of the side edges.

18. The system according to claim 16, wherein the upper edge comprises a release tab for attaching the front cover lens to the sign body

19. A method of providing customizable and changeable signs comprising the steps of:
(a) providing a computer, a printer and a display frame apparatus having a sign body including front and back faces and a transparent front cover lens releasably attached to the front face of the sign body
(b) creating customizable indicia using the computer;
(c) connecting the printer to the computer and downloading print files containing the customizable indicia from the computer to initiate printing of the customizable indicia by the printer onto the custom sign insert; and
(d) inserting the custom sign insert between the sign body and the front cover lens for display.

20. A computer readable medium storing a set of instructions for implementing and executing the method according to claim 19.
